(19) United States
(12) Patent Application Publication
(10) Pub. No.: US 2007/0211270 A1
(43) Pub. Date: Sep. 13, 2007

(54) PRINTER AND PRINT SYSTEM

(75) Inventors: Yuki Kuwahara, Matsumoto-shi (JP); Reiko Nomura, Azumino-shi (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/682,970

(22) Filed: Mar. 7, 2007

(30) Foreign Application Priority Data
Mar. 8, 2006 (JP) 2006-062013

(51) Int. Cl. G06F 15/00

(52) U.S. Cl. 358/1.9; 358/461

(57) ABSTRACT

A printer for executing printing on the basis of tone data representing a tone of one of a plurality of colors of ink, includes an input unit that inputs first tone data for a color represented by N bits per pixel and second tone data for a color represented by M bits per pixel, M being larger than N; a storage unit that stores the tone data input by the input unit, the storage unit including a plurality of storage areas, each storage area having a capacity that can store a group of the first tone data within a predetermined print range, wherein multiple storage areas are used to store the second tone data; and a print unit that executes printing on the basis of the tone data stored in the storage unit, the print unit being capable of processing both the first tone data and the second tone data.

This application is based on Japanese Patent Application No. 2006-62013 filed on Mar. 8, 2006, in Japanese Patent Office, the entire content of which is hereby incorporated by reference.

### BACKGROUND

1. Technical Field

The present invention relates to printers or the like for receiving print data including tone information for various colors and performing printing on the basis of the print data, and more particularly relates to a printer or the like capable of performing printing on the basis of print data in which the amount of tone information is different according to color while effectively using known design resources.

2. Related Art

Color printers that can perform printing using a plurality of colors have become popular. Among these color printers, printers that eject ink of multiple colors from a head are widely used. These printers perform printing on the basis of print data sent from a host device such as a personal computer. The print data includes information indicating the density or tone of each color. The printers eject ink in accordance with the information to realize a desired representation.

To improve the print representation using such printers, recent proposals including one described in, for example, Japanese Patent No. 3593877, suggest using ink of six colors, namely, black (K), cyan (C1), light cyan (C2), magenta (M1), light magenta (M2), and yellow (Y), instead of using four colors, namely, K, cyan (C), magenta (M), and Y.

Other proposals have been made suggesting allowing a printer to eject ink droplets of different sizes, thereby representing multiple tones of each color to improve the quality of printing. Exemplary measures are described in JP-A-2003-1824.

While these efforts have been made to improve the quality of printing, it is estimated that higher expectations will be placed on the technology for making the density or tone representation different for each color. A method of using two types of ink having different densities for each of the above-described predetermined colors involves preparation of many types of ink. Should ink become short, the user must replace it, which is bothersome.

To make the tone representation different for each color while using one ink cartridge for one color, the representation of tone information included in the above-described print data is made different for each color, and ink droplets are ejected in accordance with each piece of the tone information. In this case, for example, the density or tone of K and Y is represented by 2-bit data, and the density or tone of C and M is represented by 4-bit data.

For a printer that uses one ink cartridge for one color and performs printing on the basis of received print data in which the amount of tone information is different according to color, no proposals have been made in view of effective usage of known design resources, regarding the storage of the received data.

### SUMMARY

An advantage of some aspects of the invention is that it provides a printer for receiving print data including pieces of tone information for various colors and performing printing on the basis of the print data in which the amount of tone information is different according to color, while effectively using known design resources.

According to an aspect of the invention, there is provided a printer for executing printing on the basis of first tone data and second tone data representing a different tone respectively. The printer includes an input unit that inputs first tone data for a color represented by N bits per pixel and second tone data for a color represented by M bits per pixel, M being larger than N; a storage unit that stores the data input by the input unit, the storage unit including a plurality of storage areas, each storage area having a capacity that can store a predeteremined amount of the first tone data, wherein multiple storage areas are used to store the second tone data; and a print unit that executes printing on the basis of the data stored in the storage unit, the print unit being capable of processing both the first tone data and the second tone data.

For the tone data, it is preferable that identification information indicating whether the tone data is the first tone data or the second tone data be added to each group of the first tone data within the predetermined print range, and it is also preferable that the printing performed by the print unit be changed on the basis of the identification information.

According to another aspect of the invention, there is provided a print system including a host device that transmits tone data representing a tone of one of a plurality of colors of ink; and a printer that executes printing on the basis of the tone data. The host device includes a printer driver that generates first tone data for a color represented by N bits per pixel and second tone data for a color represented by M bits per pixel, M being larger than N, and that transmits the first tone data and the second tone data. The printer includes an input unit that inputs the transmitted first tone data and second tone data; a storage unit that stores the tone data input by the input unit, the storage unit including a plurality of storage areas, each storage area having a capacity that can store a group of the first tone data within a predetermined print range, wherein multiple storage areas are used to store the second tone data; and a print unit that executes printing on the basis of the tone data stored in the storage unit, the print unit being capable of processing both the first tone data and the second tone data.

Further objects and features of the present invention will become apparent from the following description of the preferred embodiments with reference to the attached drawings.

### BRIEF DESCRIPTION OF THE DRAWINGS

The invention will be described with reference to the accompanying drawings, wherein like numbers reference like elements.

FIG. 1 is a block diagram of a printer and a print system according to an embodiment of the invention.

FIG. 2 is a diagram describing data generated by a printer driver.

FIG. 3 is a diagram schematically showing exemplary memories included in a data storage unit.

FIG. 4 is a flowchart showing an exemplary printing procedure performed by the print system.

FIG. 5 is a diagram showing the usage of the memories in the case that all colors are represented by two bits per pixel.

### DESCRIPTION OF EXEMPLARY EMBODIMENT

An embodiment of the invention will be described with reference to the drawings. However, the embodiment does not limit the technical scope of the invention. In the drawings, the same or similar components are denoted by the same reference numerals or symbols.

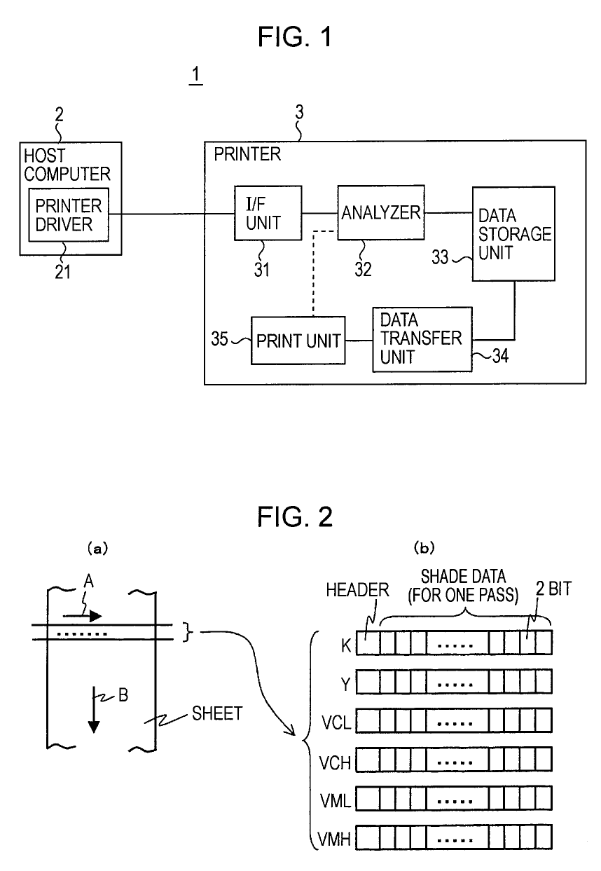

FIG. 1 is a block diagram of a printer and a print system according to an embodiment of the invention. A printer 3 shown in FIG. 1 is a printer according to the embodiment, which executes printing on the basis of print data transmitted from a host computer 2. The printer 3 is provided with a plurality of memories for storing tone data indicating the densities or tones of various colors. The memories each have a storage capacity in the case that the tone of each pixel is represented by 2-bit data. To store data for a color whose tone per pixel is represented by data of three bits or more, at least two of these memories are used to process the data. Accordingly, printing based on print data in which the amount of tone information is different according to color can be implemented while effectively using known design resources.

A print system 1 according to the embodiment has, as shown in FIG. 1, the host computer 2 and the printer 3. The host computer 2 is, for example, a personal computer and includes a printer driver 21 for the printer 3. The printer driver 21 includes a driver program installed from a recording medium or downloaded via the Internet or the like from a predetermined site and a controller that executes a process in accordance with the program.

The printer driver 21 is a component that generates, in response to a print request issued from an application such as document creation software, print data to be transmitted to the printer 3 and transmits the print data to the printer 3, thereby issuing a print request. More specifically, the printer driver 21 rasterizes color image data from the application to extract image data in units of dots and performs color conversion of the image data into data for the colors of ink used by the printer 3 and halftone processing of the converted data to generate data representing the density in a certain area on the basis of the presence of ink per dot, thereby obtaining print data including tone data for various colors per pixel. The printer driver 21 then transmits the print data to the printer 3.

In the embodiment, the printer 3 has ink of four colors, namely, black (K), yellow (Y), cyan (C), and magenta (M). In contrast, the tone data for these colors, which are generated by the printer driver 21, are such that K and Y are represented by 2-bit data, whereas C and M are represented by 4-bit data.

FIG. 2 is a diagram describing data generated by the printer driver 21. The printer 3 according to the embodiment, which will be described later, is a so-called ink jet printer. As shown in portion (a) of FIG. 2, an ink ejection head moves in a direction (which is a main scanning direction or direction A shown in portion (a) of FIG. 2) substantially orthogonal to a direction in which a sheet moves (which is a sub scanning direction or direction B shown in portion (a) of FIG. 2). Exemplary print data for one line printed by one scan (one pass) of the head, which is generated by the printer driver 21, is schematically shown in portion (b) of FIG. 2.

As shown in portion (b) of FIG. 2, the print data includes tone data (two bits) for each color per pixel and a header. The tone data is data for one pass (line). K and Y, which are expressed in terms of normal tones using two bits, are represented by one line of data. In contrast, C and M, which are expressed in terms of multiple tones using four bits, are represented by two lines of data. For C and M, the top row includes the two least significant bits of the four bits, and the bottom row includes the two most significant bits of the four bits.

Each header includes information indicating the color of subsequent tone data and the number of bits of the tone data. For example, when the header includes “K”, the tone data is 2-bit data for K. When the header includes “VCL”, the tone data is the two least significant bits of 4-bit data for C. When the header includes “VMH”, the tone data is the two most significant bits of 4-bit data for M.

The print data described above is generated by the printer driver 21 and transmitted to the printer 3.

Now, as has been described above, the printer 3 is a printing apparatus constituting the print system 1. The printer 3 is an ink jet printer that receives print data from the host computer 2 and executes printing on the basis of the print data.

The printer 3 includes an interface (I/F) unit 31, an analyzer 32, a data storage unit 33, a data transfer unit 34, and a print unit 35, as shown in FIG. 1.

The interface unit 31 is a component that receives the print data transmitted from the host computer 2. The analyzer 32 is a component that analyzes the received print data and, on the basis of the analysis result, issues various instructions for controlling the components of the printer 3. In particular, the analyzer 32 analyzes the header, which is added to each pass of tone data for each color, and determines whether the tone data is 2-bit data or 4-bit data. In accordance with the determination result, the analyzer 32 issues an instruction for the print unit 35 to change the processing details. The analyzer 32 can be constituted of a read-only memory (ROM) storing a program for issuing instructions specifying various processing details and a central processing unit (CPU) that executes a process in accordance with the program.

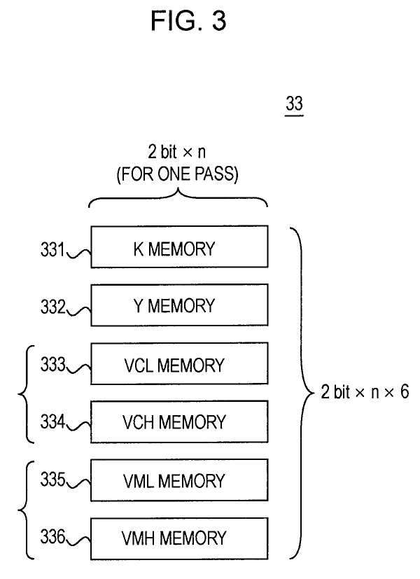

Next, the data storage unit 33 is a data buffer storing tone data for each color of the received print data. The data storage unit 33 has six memories, each of which can store one pass (line) of data for a color whose tone is represented by 2-bit data. FIG. 3 schematically illustrates these memories. As shown in FIG. 3, the six memories are prepared for data for the corresponding colors. One memory (331 and 332) is prepared for each of K and Y, and two memories (333 and 334, and 335 and 336) are prepared for each of C and M. A VCL memory 333 stores the two least significant bits of 4-bit data for C, and a VCH memory 334 stores the two most significant bits thereof. Similarly, a VML memory 335 stores the two least significant bits of 4-bit data for M, and a VMH memory 336 stores the two most significant bits thereof. In this manner, the six memories each having a capacity of 2-bit×n are prepared in the data storage unit 33 according to the embodiment. This point is a significant feature of the printer 3 and the print system 1. Note that the memories 331 to 336 may be constituted of random-access memories (RAMs).

Next, the data transfer unit 34 is a component that transfers the tone data for each color, which is stored in the data storage unit 33, to the print unit 35. Specifically, when the storage of one pass of the tone data into the data storage unit 33 is completed, the data transfer unit 34 starts transferring the stored pieces of data and sequentially processes the pieces of data at a predetermined transfer rate. When that pass contains the tone data for all the colors, the transfer begins after the recognition that the data for all the colors is stored in the data storage unit 33, and these pieces of data stored in the corresponding memories 331 to 336 are sequentially transferred. The data transfer unit 34 may be constituted of a ROM storing a program for issuing instructions specifying the processing details and a CPU that executes a process in accordance with the program. Alternatively, the data transfer unit 34 may be constituted of an application specific integrated circuit (ASIC).

The print unit 35 is a component that performs printing by ejecting ink to a print medium on the basis of the tone data transferred from the data transfer unit 34. Although not shown in FIG. 1, the print unit 35 includes a section that generates a drive pulse signal in accordance with the tone data, a plurality of nozzles prepared for the colors of ink to be ejected in response to the drive pulse signal, and a head that has the nozzles and moves in the main scanning direction. Although the print unit 35 is substantially similar to that of a known ink jet printer, the process performed by the print unit 35 is different up to the point at which the drive pulse signal is generated, depending on whether the tone data is 2-bit data or 4-bit data.

In the process up to the point at which the drive pulse signal is generated, specifically, pulse selection data is generated in accordance with the tone data. This pulse selection data is for selecting the waveform to be actually applied from among a plurality of waveforms of preliminarily prepared basic signals. By selecting the waveform on the basis of the pulse selection data, a drive pulse signal corresponding to the tone data is generated.

For example, when the tone data includes 2-bit data, four types of densities or tones can be represented. For example, ink is ejected without dots or with small dots, medium dots, or large dots in accordance with the tone data. The pulse selection data is generated to produce a drive pulse signal for causing the ink to be ejected in accordance with the tone data. In contrast, when the tone data includes 4-bit data, five or more types of densities or tones can be represented. Therefore, dots are formed in more detailed, different manners. In accordance with the detailed formation of dots, pulse selection data is generated, and, furthermore, a drive pulse signal is generated.

The print unit 35 according to the embodiment can handle both types of tone data, that is, whether the tone data is 2-bit data or 4-bit data. The process is switched between two modes on the basis of an instruction issued from the analyzer 32.

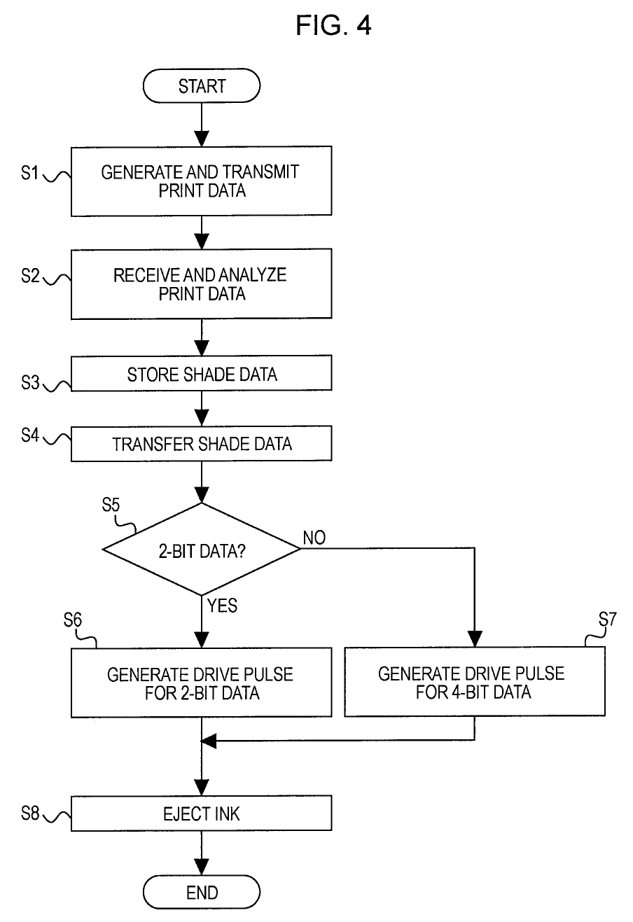

The print system 1 according to the embodiment, which has the above-described structure, can handle printing based on print data in which the amount of tone information is different according to color. A specific printing procedure will be described below. FIG. 4 is a flowchart showing an exemplary printing procedure performed by the print system 1.

When a user gives a print instruction to an application on the host computer 2, the printer driver 21 receives a print request from the application, generates print data in accordance with the request, and transmits the print data to the printer 3 (step S1). Specifically, as has been described above, the printer driver 21 performs rasterizing, color conversion, and halftone processing to generate print data including pieces of tone data and their headers, such as those shown in portion (b) of FIG. 2. The printer driver 21 sequentially transmits these pieces of data representing the colors, one pass at a time.

When the data is transmitted to the printer 3 in this manner, the printer 3 receives the sequentially transmitted pieces of print data via the interface unit 31, and the analyzer 32 of the printer 3 analyzes the received data (step S2). Specifically, as has been described above, the analyzer 32 analyzes information in the header included in the print data and issues instructions to the components of the printer 3. In particular, the analyzer 32 determines whether the received tone data is 2-bit data or 4-bit data on the basis of the header information. When the number of bits of the received tone data is different from that of the previously received tone data, the analyzer 32 issues an instruction to the print unit 35 to change the mode of the process when processing this data.

Next, the tone data of the received print data is transmitted to the data storage unit 33 and stored in the corresponding memories 331 to 336 (step S3). As has been described above, pieces of print data are sequentially transmitted, one pass at a time. The received pieces of tone data for the colors are sequentially stored in the memories for the corresponding colors, which are shown in FIG. 3. For C and M, as has been described above, two memories are used to store the most significant bits and the least significant bits, respectively.

The data is stored in this manner. When all the pieces of tone data for one pass are stored in the data storage unit 33, the data transfer unit 34 sequentially reads the stored pieces of tone data and transfers the tone data to the print unit 35 (step S4). The process of transferring the tone data is the same for any color and is performed at a certain transfer rate.

As has been described above, the data is transferred to the print unit 35, which in turn performs a process to generate the drive pulse signal. When the transferred tone data to be processed is 2-bit data (“Yes” in step S5), the process in the above-described 2-bit mode is performed to generate a drive pulse signal for 2-bit data (step S6). In contrast, when the transferred tone data to be processed is 4-bit data (“No” in step S5), the process in the above-described 4-bit mode is performed to generate a drive pulse signal for 4-bit data (step S7). As has been described above, the analyzer 32 determines whether the tone data is 2-bit data or 4-bit data. The print unit 35 is only required to change the mode of the process in accordance with an instruction from the analyzer 32. When the tone data is 4-bit data, that is, when the data represents C or M, data transferred from the memory for the least significant bits and data transferred from the memory for the most significant bits are combined in the print unit 35 to generate 4-bit data, based on which a process to generate the drive pulse signal is performed thereafter.

When the drive pulse signal is generated in this manner, the signal is applied with a predetermined timing to allow the nozzles of different colors to eject ink (step S8). As the head moves, the nozzles sequentially eject ink to perform printing on a print medium.

The above-described process is repeated to execute the requested print job.

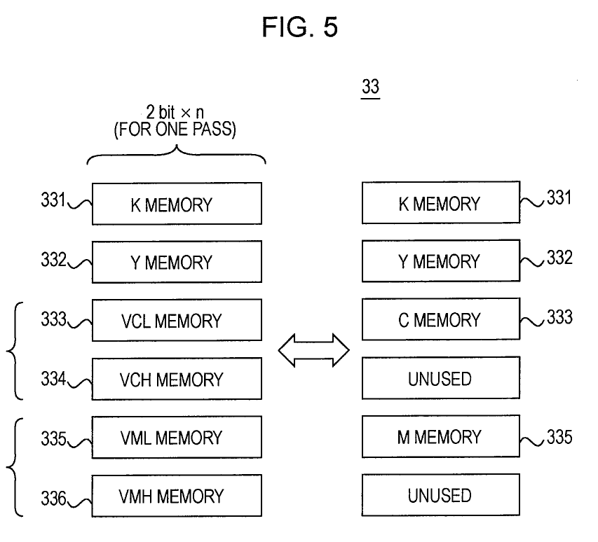

In the above description, print data including 2-bit tone data for K and Y and 4-bit tone data for C and M is received by the printer 3. However, the printer 3 can receive and handle print data including 2-bit tone data for all the colors. FIG. 5 is a diagram showing an example of the usage of the memories 331 to 336 in such a case. In the case that all the colors are represented by 2-bit data, only four out of six memories are used, one memory for one color. For example, as shown in the right portion of FIG. 5, the memories 331, 332, 333, and 335 are allocated to K, Y, C, and M, respectively. Besides this point, the print process is executed in the same manner as the above-described processing details. Since the tone data is always 2-bit data, the analyzer 32 issues no switching signal. The print unit 35 always performs the process in the 2-bit mode.

As has been described above, in the print system 1 according to the embodiment, the host computer 2 generates print data including 2-bit data representing the tone of K and Y and 4-bit data representing the tone of C and M. The printer 3 receiving the print data has six memories, each having a capacity of storing one pass of data in 2-bit units. One memory is used to store data for each of K and Y, and two memories are used to store data for each of C and M. The print unit 35 is constructed to handle both the 2-bit data and the 4-bit data. The process performed by the print unit 35 is switched between the two modes on the basis of the header information included in the print data.

In contrast to a known print system for generating and processing print data including 2-bit tone data for all the colors K, Y, C, and M, the print system 1 has the additional features: print data in which the amount of information is different according to color is generated; two additional memories, each having a capacity of storing one pass of data in 2-bit units, are provided; and the print unit 35 includes a system for generating a drive pulse signal for 4-bit data such that the process can be switched between the two modes. No changes are added to the data transfer rate or the size of a data transfer bus from the data storage unit 33.

According to the print system 1, high-quality printing based on print data in which the amount of tone information is different according to color can be realized while known design resources are put to effective use.

As has been described above, the printer 3 can receive and process print data including 2-bit tone data for all the colors K, Y, C, and M. This one type of printer can produce various types of tone representations using each color of ink.

Although the print data includes both 2-bit tone data and 4-bit tone data in the above-described embodiment, the amount of information per pixel, such as two bits or four bits, is only exemplary. The invention is applicable to any print data as long as the print data includes tone information of different amounts according to color. That is, a plurality of memories, each having a capacity corresponding to data for a color represented by the least amount of information, are prepared. To store data for a color represented by a large amount of information, multiple memories are used. The print unit 35 has a drive pulse generating function according to the amount of information. For example, the invention is applicable to the case in which K and Y are represented by 2-bit tone data and C and M are represented by 3-bit tone data.

Although the halftoned print data is transmitted from the host computer 2 in the above embodiment, the print data may be generated by the printer 3. For example, the printer 3 may receive data that has not been rasterized from the host computer 2, and the printer 3 may perform the above-described rasterizing, color conversion, and halftone processing to generate print data including the above-described tone data. Even in this case, the subsequent process cab be similarly performed.

It is intended that the invention is not limited to the above embodiment and that the invention cover all the variations and modifications of the invention, provided they come within the scope of the appended claims and their equivalents.

What is claimed is:

1. A printer for executing printing on the basis of first tone data and second tone data, comprising:
an input unit that inputs the first tone data for a color represented by N bits per pixel and the second tone data for a color represented by M bits per pixel, M being larger than N;
a storage unit that stores the data input by the input unit, the storage unit including a plurality of storage areas, each storage area having a capacity that can store a predeteremined amount of the first tone data, wherein multiple storage areas are used to store the second tone data; and
a print unit that executes printing on the basis of the data stored in the storage unit.

2. The printer according to claim 1, wherein an identification information indicating either the first tone data or the second tone data is added to each data stored in each storage area, and a processing for the printing by the print unit is changed on the basis of the identification information.

3. A print system comprising:
a host device that generates first tone data for a color represented by N bits per pixel and second tone data for a color represented by M bits per pixel, M being larger than N, and that transmits the first tone data and the second tone data, and
a printer includes
an input unit that inputs the transmitted data,
a storage unit that stores the data input by the input unit, the storage unit including a plurality of storage areas, each storage area having a capacity that can store a predeteremined amount of the first tone data, wherein multiple storage areas are used to store the second tone data, and
a print unit that executes printing on the basis of the data stored in the storage unit.
